(19) United States
(12) Patent Application Publication
(10) Pub. No.: US 2026/0355887 A1
(43) Pub. Date: Nov. 12, 2026

(54) JOINING SYSTEM

(71) Applicant: Kistler Holding AG, Winterthur (CH)

(72) Inventors: Peter BALZER, Schwäbisch Gmünd (DE); Peter René JENSEN, Holbaek (DK); Stefan KOCH, Hettlingen (CH)

(21) Appl. No.: 19/669,144

(22) Filed: May 6, 2026

(30) Foreign Application Priority Data
May 7, 2025 (EP) 25174884.4

(51) Int. Cl. B23Q 17/09

(52) U.S. Cl. CPC B23Q 17/0966

(57) ABSTRACT

A joining system includes a force transducer between an actuator and a joining tool, which is operationally connected to an accelerometer that measures an acceleration of the joining tool during operation of the joining system.

### TECHNICAL FIELD

The invention relates to an electromechanical joining system that includes an accelerometer.

### BACKGROUND OF THE INVENTION

Joining systems are used in industrial production and are employed to connect workpieces, also known as components, joining bodies, or structural elements, using various processes such as press-fitting, clinching, riveting, and/or caulking. These processes are grouped under the generic term joining processes, whereby workpieces are connected to each other through the joining procedure. Sometimes joining processes are used in conjunction with other joining techniques such as welding and/or bonding. Joining systems, also known as press-fit systems, use mechanical force to join workpieces and are widely used in the automotive industry, among others.

Joining systems are particularly suitable for applications where medium to high forces must be applied to permanently join workpieces. These systems offer high repeatability and process reliability, making them ideal for series production. Joining systems are very flexible in their application due to the wide range of uses. Applications include, for example, press-fitting, i.e. the mechanical joining of components by pressing one part into another. Press-fitting is used in the automotive industry, for example, to assemble bearings, bushings, and other components. Caulking is a joining process for mechanically connecting components by plastic deformation. This technique is used, for example, in the production of housings and containers. Another joining process is riveting, i.e. joining components by inserting a rivet through the parts to be joined and then deforming it to create a strong connection. Joining systems are also used for clinching, which joins sheet metal without additional connecting elements by means of plastic deformation, or for snapping or clipping one part into another, for example by means of a snap connection. This technique is often used in electronics and plastics processing. Joining systems are also used to close openings, but also for press-fitting, in particular for press-fitting balls into components to create a firm connection, for example in bearing technology. Other applications of joining systems include crimping or setting force, the latter for positioning a component in a specific position.

Applications of joining systems also include testing procedures in which a force is determined, for example, testing a spring force in spring testing or testing the elastic properties of materials to check their ability to return to their original shape after deformation, as well as plug-in force and pull-out force testing of plug contacts or plug connections.

In the various applications, the components on which a force is exerted by a joining tool vary greatly. This document therefore generally uses the term workpiece. Said workpiece can be, for example, a test piece, an element to be joined, a connecting element, or the like, depending on the intended applications of the joining system.

Well-known joining systems are often equipped with a control element that enables integration into automated production lines. A joining system comprises a drive that moves an actuator relative to a stator. The actuator comprises a joining tool with which a force is applied to the workpieces to be joined for a joining procedure. Pneumatic, hydraulic, and electromechanical drives are known, whereby electromechanical drives are generally deemed to be more energy-efficient than hydraulic and pneumatic drives.

An efficient joining procedure is characterized by the fact that the force applied corresponds precisely to the target force for the respective application. The target force is the force with which the joining process should be carried out in order to achieve optimum results. Applying a higher force is not energy-efficient, as more energy is required than is necessary for the joining process. In addition, workpieces can be damaged or even destroyed, rendering them unusable and leading to increased scrap. A force lower than the target force can also lead to high scrap rates and unusable workpieces, for example if the force is insufficient to complete a joining process and workpieces are not joined together or are not joined together sufficiently.

Joining systems are known, for example from EP2456594A1, which corresponds to applicant's commonly owned US Patent Application Publication No. 2012-0090168 that is hereby incorporated herein in its entirety for all purposes, comprises a force transducer in the area of the joining tool. During the joining process, said joining tool is moved towards the workpiece in order to apply a joining force to the workpiece. The force transducer is arranged in the main force connection or at least in the force shunt between the drive and said joining tool in order to directly determine the force acting on the joining tool. According to Newton's 3rd law, the force acting on the joining tool is equal to the force acting on the joining body. The target force can be applied via force feedback to the drive. However, the mass of the joining tool or all masses, respectively, which are located between the force transducer and the workpiece is disruptive, as they also exert a force on the force transducer due to inertia during the acceleration that occurs during the joining procedure. This is often negligible in known joining systems with speeds of less than 400 mm/s, but at higher speeds distorts the determination of the force, so that the determined force does not exactly correspond to the joining force actually acting on the workpiece.

However, the speed of a joining system or actuator, respectively, determines the number of joining operations per unit of time. However, it is not possible to increase efficiency by increasing the speed of the actuator without negatively affecting the force measurement by the force transducer due to the higher acceleration that occurs with the increase in speed.

### OBJECTS AND SUMMARY OF THE INVENTION

The object of the invention is to provide a joining system that is configured so as to reduce the aforementioned disadvantages.

This object is achieved by the features described below.

The invention relates to a joining system for applying a joining force to a workpiece. Said joining system comprises a stator. Said joining system also comprises a drive. Said joining system also comprises an actuator. Said actuator comprises a rigid connection to a force transducer. The force transducer comprises a rigid connection to a joining tool. Said actuator is arranged so that it can be moved in a controlled manner relative to the stator. The joining tool is arranged in operative connection with the actuator in such a way that said joining tool is designed to apply the joining force to the workpiece. The force transducer is arranged between the actuator and the joining tool, whereby the force transducer is configured to detect a force acting on the joining tool. The term operative connection refers to a rigid connection that is suitable for transmitting an effect, for example a force effect.

According to the invention, an accelerometer is arranged in operative connection with the joining tool. Said accelerometer is configured and disposed so as to detect an acceleration of the joining tool.

This is advantageous because the knowledge of the acceleration of the joining tool allows conclusions to be drawn about any resulting deviation of the detected force from the desired joining force.

Preferably, said joining system comprises a signal processing device. The signal processing device is configured to detect an acceleration value from the accelerometer. In addition, said signal processing device is configured to detect a force value from the force transducer. Said signal processing device is configured to combine the force value and the acceleration value and to determine an acceleration-compensated force value, referred to as the joining force value for short. Due to the acceleration of the joining tool, a force proportional to the acceleration acts on the force transducer as a result of the mass of the joining tool. The force transducer therefore detects both the force caused by this acceleration and the joining force acting on the workpiece as soon as the joining tool comes into contact with the workpiece. Since only the joining force value is to be determined, it is advantageous to determine the acceleration and to determine an acceleration force using a previously determined mass of the joining tool. The acceleration force corresponds to the product of the acceleration value and the mass of the joining tool. The mass of the joining tool corresponds to all masses located between the workpiece and the force transducer.

Preferably, said signal processing device is configured to record the acceleration value simultaneously with the force value. The signal processing device is configured to combine the simultaneously recorded force value and acceleration value and to determine a joining force value. The simultaneous detection and combination of the force value and acceleration value has the advantage that the joining force value is determined directly and made available for further use. Subsequent temporal synchronization of a temporal sequence of determined force values with a temporal sequence of determined acceleration values is alternatively possible, but is not necessary in the case of simultaneous determination. Thus, said joining force value can be determined with virtually no time delay.

Simultaneous recording, also referred to as concurrency of recording or simultaneous recording, is understood to mean a delay between the recording of the force value and the recording of the acceleration value of less than 100 microseconds, preferably less than 50 microseconds.

The signal processing device preferably comprises an algorithm which is configured to determine the joining force value from the force value and the acceleration value. Said algorithm is configured to determine the joining force value as a function of the product of the acceleration value and an optional acceleration correction factor added to the product of the force value and an optional force correction factor added to the sum of an optional force offset and an optional acceleration offset. The algorithm run on the signal processing device provides the joining force value for further use.

Preferably, the joining system comprises a control device. Said control device is configured to control the drive. The control device thereby is configured to control the movement of the actuator relative to the stator. The control device may comprise an algorithm. The control device is preferably configured to detect the joining force value. The joining force value is provided by the signal processing device. The control device is configured to compare the joining force value with a target force. The target force is the force to be applied to the workpiece. The control device is configured to move the actuator in such a way that the joining force value approximates the target force. This is advantageous because the joining tool applies the force to the workpiece that is optimal for the joining process. It is also possible to identify signatures for snapping into place or clipping together in the joining force over time. This signature can serve as a signal for a change in the setpoint. For example, after the recognized signature of a snapping into place, the target force for the further joining process can thus be increased or decreased, the joining process can be terminated immediately or after a certain time by moving the actuator back to a starting position, or the speed of the movement of the joining process can be adjusted.

Particularly preferred, said joining system comprises a displacement sensor. Said displacement sensor is configured to determine a displacement value and provide the displacement value for further use. The displacement value can be clearly assigned to a spatial position of the joining tool. Since the actuator is firmly connected to the joining tool, the displacement value can also be assigned to a corresponding relative position of the actuator and stator. This has the advantage that even complex joining procedures are possible in which the joining force is required to apply different forces to the workpiece depending on the position of the joining tool. It is also possible to record signatures for snapping into place or clipping together both in the temporal course of the joining force and in the local course of the joining force. Thus, in addition to the advantages of a recognized snap together signature, a specific distance can also be specified for the further joining process. For example, after a snap together signature has been recognized, a distance can be specified for which the joining process is to be continued, optionally with adjustment of the joining speed and/or the target force.

It can also be particularly advantageous to specify a target force which is dependent on the displacement value. The joining process can be carried out in such a way that a specific target force is specified as a function of position and/or time and is applied precisely to the workpiece by the control device, which desirably is configured for taking into account the joining force value and the displacement value.

The advantages of the invention and the preferred features are particularly evident when the actuator is moved with respect to the stator at a speed of more than 400 mm·s⁻¹ (millimeters per second). The number of joining processes per unit of time should usually be high in order to be able to process as many workpieces as possible in the shortest possible time and thus keep the production costs of the workpiece low. However, due to the problems mentioned above, joining mod-ules with speeds below 400 mm·s⁻¹ are usually used. In a joining process, the actuator is moved towards the workpiece at the start of a joining process from a starting position, often referred to as the zero position, initial position, or starting position, relative to the stator. Thereby, the joining tool travels a free distance before coming into contact with the workpiece. The free distance is necessary in order to remove a processed workpiece after a joining process has been completed and to provide a new workpiece for processing by the joining tool. This free distance should be overcome as quickly as possible. This requires a high speed, which results in high acceleration of the joining tool. Before reaching the known position of the workpiece, the movement of the joining tool can also be slowed down to avoid hitting the workpiece, which also results in high acceleration of the joining tool. Even after initial contact with the workpiece, the speed of the joining process can be changed in order to complete the joining process in the shortest possible time. It is therefore particularly advantageous to move the actuator with respect to the stator at a speed of more than 1500 mm·s⁻¹.

It is preferable for the signal processing device to be configured to record the force value and the acceleration value at a sampling rate of at least 1 kHz, preferably 10 kHz. Alternatively, the signal processing device is configured to record the force value and the acceleration value at least every millisecond, particularly preferably at least every 100 microseconds. This is advantageous because signatures, for example abrupt changes, in the joining force value, such as an increase in the joining force upon initial contact with the workpiece, or the abrupt increase that might result from a clip together or snap into place connection, can be detected quickly and the target force and/or speed, and the like, can be adjusted. This ensures that the optimum target force is applied to the workpiece as joining force at every point in the joining process.

Preferably, the joining system comprises at least one brake. Said brake is configured to brake the movement of the actuator relative to the stator. This results in higher acceleration forces than when controlling the speed via the drive. The brake can be controlled by the control device in an analogous way as the drive. The brake is configured to reduce the speed of the actuator relative to the stator and/or to lock the actuator relative to the stator. The faster braking reduces the processing time of a workpiece.

Preferably, said drive is designed as an electromechanical drive. Electromechanical drives can be moved more precisely than pneumatic or hydraulic drives. In addition, electromechanical drives offer higher energy efficiency. The actuator can be adjusted in a linear manner relative to the stator by means of the drive. The stator is a fixed part of the joining system. The stator is usually located in a fixed position in a room, for example, a production hall. The actuator can be, for example, a threaded element that elongates along a longitudinal axis and that is configured to be moved along the longitudinal axis by a hollow shaft of the drive.

To prevent the actuator and thus the joining tool from twisting, the actuator is connected to the stator in a movable manner by at least one linear guide, preferably two linear guides. The linear guide restricts the linear movement of the actuator to one spatial axis.

The force transducer is configured, for example, as a piezoelectric force transducer or as a piezoresistive force transducer or as a force transducer comprising strain gauges. Advantageously, said accelerometer is a piezoelectric accelerometer with high impedance and charge mode that easily can be converted into a usable analog voltage signal via a charge amplifier. However, other embodiments of an accelerometer are also conceivable. The force transducer is arranged between the joining tool and the actuator. This has the advantage that the force is determined close to the joining tool, which joining tool applies the joining force to the workpiece. The particular disposition of the force transducer avoids the presence of force shunts that otherwise would detract from accuracy of the force being measured by the force transducer. Disturbing influences, for example due to many intermediate elements such as housing walls or other structures that would form a force shunt parallel to force sensor or force shunt connections, which absorb part of the force that otherwise would be detected by the force transducer, are reduced. The force transducer thus is advantageously arranged in the main force connection, also known as the primary force connection, between the joining tool and the actuator. The main force connection is that force connection at which the highest proportion of the force is applied to the force transducer. The terms force connection, main force connection, and force shunt connection are interpreted according to Chapter 9.2 of the publication «Piezoelektrische Meßtechnik» by G. Gautschi, Springer Verlag, 1980. The arrangement of the force transducer in the main force connection is advantageous because it means that most of the force acting on the workpiece also acts on the force transducer. This improves the measurement accuracy of the joining force compared to joining systems in which the force transducer is arranged in a force shunt connection and is exposed to a smaller proportion of the joining force.

It may also be envisaged that the joining system comprises a plurality of joining tools. The plurality of joining tools are arranged in operative connection with the one actuator in such a way that the joining tools are each designed to apply a joining force. For this purpose, the workpiece optionally is arranged in a movable manner so that it can be moved under the joining tool that is to perform the next joining operation. Alternatively, the joining tools can also be arranged in a movable manner on the actuator, for example in a joining tool turret, also known as a tool turret or turret holder. A force transducer is arranged between each joining tool and the actuator. The signal processing device is configured to switch between the force transducers according to the joining tool used and to determine the joining force value based on the respective force value and the previously determined inertial mass of the respective joining tool. Furthermore, only one accelerometer is provided, since the plurality of joining tools are moved collectively by the same actuator that is attached to the accelerometer. This is advantageous because complex joining processes that require different joining tools can be performed with a single joining system.

A joining tool can be, for example, a holder that holds a workpiece part. The holder can, for example, be moved to the workpiece and the sub-assembly can be attached to the workpiece. After changing the joining tool to a plunger, said sub-assembly can be pressed against the workpiece by means of said plunger, for example to snap it into the workpiece.

A process according to the invention for applying a joining force to a workpiece by means of a joining system implies that the drive moves the actuator against the stator in a controlled manner. The actuator starts the movement from the starting position and is accelerated from there in the direction of the workpiece. The actuator is rigidly connected to at least the force transducer and at least one joining tool, whereby the force transducer determines the force acting on the joining tool as a force value. The joining tool is arranged in operative connection with the actuator in such a way that the joining tool is moved in the direction of a workpiece in order to apply a joining force to the workpiece. The movement causes an acceleration of the joining tool, which exerts a force on the force transducer, which is arranged between the actuator and the joining tool in order to determine the force acting on the joining tool. The accelerometer is arranged in operative connection with the joining tool and determines the acceleration of the joining tool as an acceleration value. The drive moves the actuator as a function of the force value and acceleration value in order to adjust the joining force value to a predefined target force value.

In the process, it is advantageously envisaged that the signal processing device detects the acceleration value of the accelerometer and detects the force value of the force transducer. The signal processing device comprises an algorithm which determines an acceleration-compensated force value, referred to as the joining force value for short, from the force value and the acceleration value. The signal processing device provides the joining force value. This joining force value can be implemented as an analog signal or digital signal in an electrical, electronic, or optoelectronic manner. Advantageously, the control device detects the provided joining force value and compares the joining force value with the target force. As already described, the target force can be time-dependent and/or position-dependent and/or event-dependent. An event, for example, is the occurrence of a signature of a clip together or snap-into place or the exceeding or falling below of a predefined joining force value. The control device moves the actuator depending on the difference between the target force and the joining force value.

The signal processing device advantageously is configured to detect the acceleration value at the same time as the force value, whereby the delay between the detection of the force value and the detection of the acceleration value is less than or equal to 100 microseconds, preferably less than 50 microseconds. Advantageously, the displacement sensor is configured to detect the spatial position of the joining tool unambiguously as a displacement value. The target force may be dependent on the displacement value.

The process is preferably used in a joining system in which the actuator moves at a speed of more than 400 mm·s⁻¹ relative to the stator. The actuator preferably moves at a speed of more than 1500 mm·s⁻¹ relative to the stator. The signal processing device detects the force value and the acceleration value at a sampling rate of at least 1 kHz, preferably 10 kHz. Alternatively, the signal processing device detects the force value and the acceleration value at least every millisecond, preferably at least every 100 microseconds.

Preferably, in the process, the joining force is established and provided by means of an algorithm of the signal processing device as the sum of the product of the acceleration value and the acceleration correction factor and the product of the force value and the force correction factor and a force offset and an acceleration offset.

Of course, the joining force can also be determined in an alternative manner. For example, the force correction factor and/or the acceleration correction factor and/or the force offset and/or the acceleration offset can be dependent on the current speed of the joining tool and/or the current acceleration value of the joining tool and/or the currently determined force value.

### BRIEF DESCRIPTION OF THE DRAWINGS

In the following, the invention is explained in more detail with reference to the Figures, in which:

FIG. 1 shows a schematic representation of a joining system according to the state of the art,

FIG. 2 shows a schematic representation of an embodiment of a joining system,

FIG. 3 shows a schematic representation of a further embodiment of a joining system,

FIG. 4 shows a schematic representation of a still further embodiment of a joining system,

FIG. 5A shows a schematic representation of the acceleration-compensated force value (Joining force value),

FIG. 5B shows a schematic representation of the force value,

FIG. 5C shows a schematic representation of the acceleration value with an acceleration correction factor,

FIG. 6 shows a schematic representation of yet a further embodiment of a joining system.

### DETAILED DESCRIPTION OF EXEMPLARY EMBODIMENTS OF THE INVENTION

Identical elements or elements with the same function are marked with the same reference numerals in the figures.

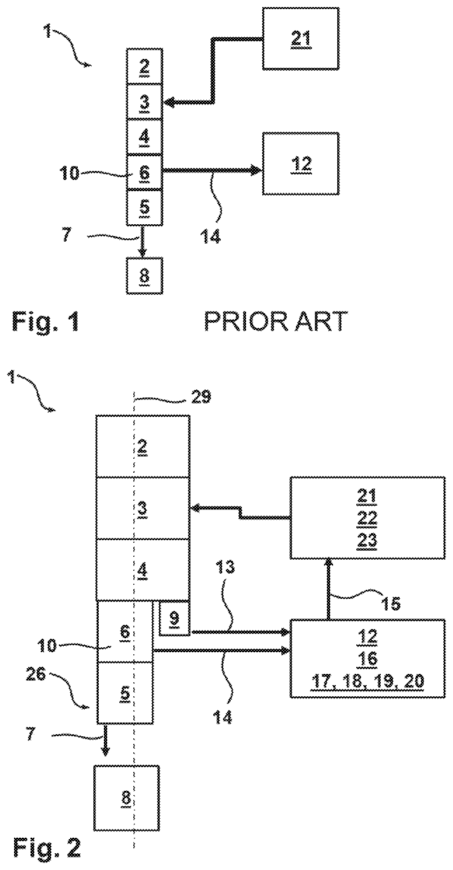

FIG. 1 presents a schematic representation that shows a joining system 1 for applying a joining force 7 to a workpiece 8 according to the state of the art. The joining system 1 comprises a stator 2 connected to a drive 3, which is connected to an actuator 4. The drive 3 is connected to a control device 21. The actuator 4 comprises a rigid connection to a force transducer 6, which force transducer 6 comprises a rigid connection to a joining tool 5. The actuator 4 is arranged in such a way that it can be moved by the drive 3 in a controlled manner relative to the stator 2, and the joining tool 5 is arranged in operative connection with the actuator 4 in such a manner that the joining tool 5 is configured to apply the joining force 7 to the workpiece 8. Said force transducer 6 is arranged between the actuator 4 and the joining tool 5 and is configured to detect a force 10 acting on the joining tool 5. The force 10 is provided as a force value 14 to a signal processing device 12.

FIG. 2 shows a schematic representation of an embodiment of a joining system 1 for applying a joining force 7 to a workpiece 8. This joining system 1 also comprises the elements known from the prior art, namely a stator 2 connected to a drive 3, which is connected to an actuator 4. NTI AG (www.linmot.com) for example, headquartered in Spreitenbach, Switzerland, and having its US headquarters in Lake Geneva, Wisconsin, offers a range of suitable drives that includes in particular Modul DM03. The drive 3 is connected to a control unit 21 that is configured to control operation of the drive 3. The actuator 4 comprises a rigid connection to a force transducer 6, which force transducer 6 comprises a rigid connection to a joining tool 5. The actuator 4 is arranged in such a way that it can be moved by the drive 3 in a controlled manner relative to the stator 2, and the joining tool 5 is arranged in operative connection with the actuator 4 in such a way that the joining tool 5 is configured to apply the joining force 7 to the workpiece 8. Said force transducer 6 is arranged between the actuator 4 and the joining tool 5 and is configured to detect a force 10 acting on the joining tool 5. As schematically shown in FIGS. 2-4, 5B and 6 , the force 10 is provided as a force value 14 to a signal processing device 12. However, as the speed with which the drive 3 moves actuator 4, and accordingly moves the joining tool 5, increases, the degree to which the joining tool 5 undergoes acceleration can contribute to the force value 14 transmitted to the signal processing device 12. Thus, in addition to the elements of the same function from the prior art, the embodiment of FIG. 2 according to the invention further comprises an accelerometer 9. Said accelerometer 9 is configured to detect acceleration of the joining tool 5 and to provide a measure of that acceleration as an acceleration value 13.

The signal processing device 12 of the embodiment shown in FIG. 2 is configured to receive and process the acceleration value 13 and the force value 14. As schematically shown in FIGS. 2-4, 5A and 6 , said signal processing device 12 is configured to combine the force value 14 and the acceleration value 13 and to determine and provide an acceleration-compensated force value 15, referred to as the joining force value 15 for short.

The control device 21 is configured to control the drive 3 in such a manner that the joining force value 15 approximates the target force value 23. For this purpose, the control device 21 is configured to run an algorithm 22 that compares the joining force value 15 with the target force value 23.

The signal processing device 12 shows, by way of example, the algorithm 16 which is configured to determine the joining force value 15 as a first sum of a first product of the acceleration value 13 and the acceleration correction factor 17, which first product is then added to a second product of the force value 14 and the force correction factor 18. The first sum so determined, can be added to a second sum of a force offset 19 and an acceleration offset 20, which second sum typically will be zero unless some initial conditions require these offsets 19 and/or 20 for the purpose of calibrating such initial conditions.

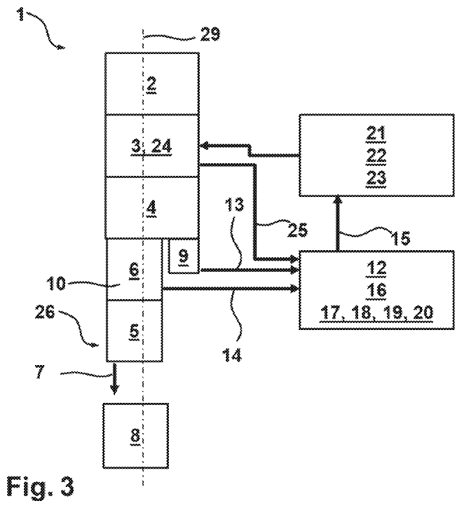

FIG. 3 shows a further embodiment of a joining system. In addition to the features of the embodiment of FIG. 2, this embodiment comprises a displacement sensor 24 which is configured and disposed to provide a displacement value 25, which is a value that uniquely determines a spatial position of the joining tool 5. The displacement sensor 25 desirably is configured as a conventional linear encoder that pairs a sensor with a scale that encodes position that is converted into an analog or digital signal, which signal then can be decoded into a spatial position value by a digital readout or a motion controller. Given that the actuator 4 is firmly connected to the joining tool 5, the relative position of the actuator 4 and stator 2 can be derived from the displacement value 25. The control device 21 is configured to take the displacement value 25 into account for controlling the drive 3. For example, the target force value may depend on the displacement value, as described above.

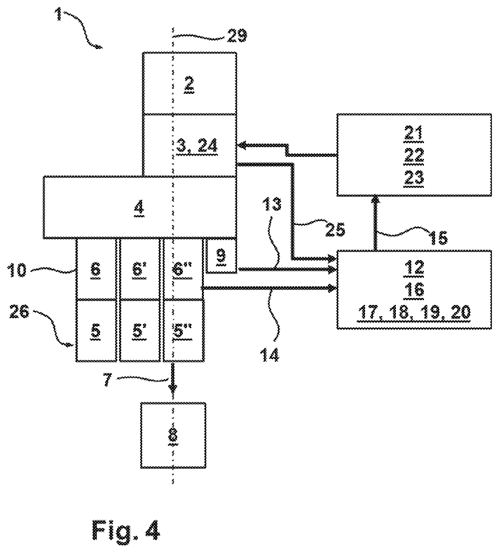

FIG. 4 shows a schematic representation of a further embodiment of a joining system. In contrast to the embodiments already described in FIG. 2 and FIG. 3, this embodiment of FIG. 4 shows a plurality of joining tools 5, 5′, 5″ with a plurality of force transducers 6, 6′, 6″ in operative connection with the actuator 4. The signal processing device 12 is configured to receive and process the force value of each respective joining tool 5, 5′, 5″, which exerts a force 10 on the workpiece 8 during the respective joining process. Since all joining tools 5, 5′, 5″ are firmly connected in operative connection with the actuator 4, only one accelerometer 9 connected to the actuator 4 is required to detect the acceleration value for determining the joining value 15.

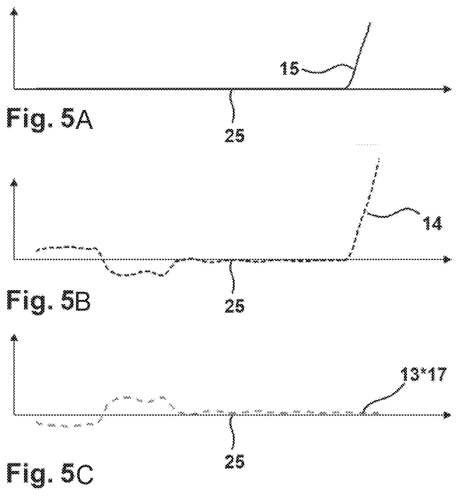

FIG. 5B exemplarily shows a force value 14 against the displacement value 25. The vertical axis represents a force in arbitrary units. The force value 14 initially shows a positive force acting on the force transducer 6, which is exerted on the force transducer 6 by acceleration of the joining tool 5. This is particularly clear when compared with the corresponding force from FIG. 5C, which corresponds to the acceleration value 13 and an acceleration correction factor 17. The acceleration correction factor 17 includes the mass of the joining tool and is already assigned a factor of −1, and therefore shows the force to be added to the force value 14 in order to obtain the joining force value 15, which is shown in FIG. 5A. The force value in 5B changes to the negative range, which indicates braking of the joining tool. This can be seen in an analogous manner in the acceleration value 13 in FIG. 5C. This is followed by a range with more constant speed, in which no acceleration force acts on the force transducer 6. The speed is also maintained when the tool hits the workpiece. The force value 14 increases, but the acceleration value 13 remains constant at zero.

The illustrations in FIG. 5A, B, and C show only the beginning of a joining process as an example. The end of the joining process with corresponding braking of the joining tool 5 is not shown.

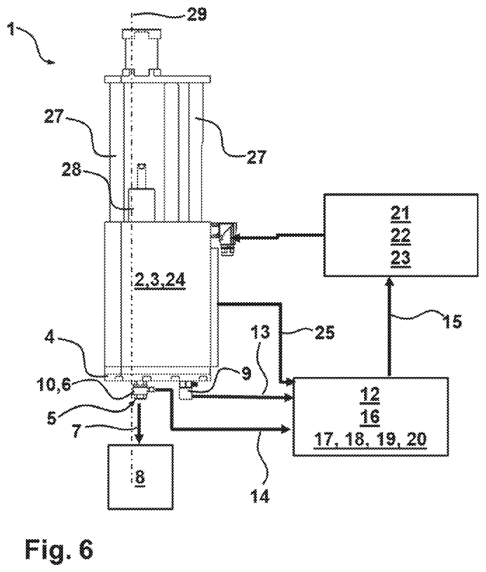

FIG. 6 shows a schematic representation of a further embodiment of a joining system 1. The drive 3 is configured as an electromechanical drive 3, and the actuator 4 is partially visible in a plate shape at the lower end of the stator 2. The joining system comprises a brake 28 and two linear guides 27, which restrict the movement of the actuator to a spatial axis 29 in order to prevent unwanted twisting of the joining tool.

### LIST OF REFERENCE SYMBOLS

1 Joining System
2 Stator
3 Drive
4 Actuator
5, 5′, 5″, Joining tool
6, 6′, 6″, Housing abutment surface
7 Joining force
8 Workpiece
9 Accelerometer
10 Force
11 Acceleration
12 Signal processing device
13 Acceleration value (Acceleration signal)
14 Force value (Force signal)
15 Acceleration-compensated force value (Joining force value)
16 Algorithm (Signal processing device)
17 Acceleration correction factor
18 Force correction factor
19 Force offset
20 Acceleration offset
21 Control device
22 Algorithm
23 Target force (Target force value)
24 Displacement sensor
25 Displacement value
26 Position
27 Linear guide
28 Brake
29 Spatial axis

What is claimed is:

1. A joining system for applying a joining force to a workpiece, the joining system comprising:
a stator;
an actuator configured moveable in a controlled manner relative to the stator;
a drive disposed in operative connection with the stator and the actuator;
a joining tool configured and disposed in operative connection with the actuator in such a way that the joining tool is configured to apply the joining force to the workpiece;
a force transducer disposed between the actuator and the joining tool and rigidly connected to the actuator and to the joining tool, wherein the force transducer is configured to detect a force acting on the joining tool; and
an accelerometer arranged in operative connection with the joining tool and configured to detect an acceleration of the joining tool.

2. The joining system according to claim 1, further comprising a signal processing device configured to detect an acceleration value generated by the accelerometer and a force value generated by the force sensor; and
wherein the signal processing device is configured to combine the force value and the acceleration value and to determine an acceleration-compensated force value.

3. The joining system according to claim 2, wherein the signal processing device is configured to detect the acceleration value simultaneously with the force value and combine the simultaneously detected force value and the acceleration value to determine the acceleration-compensated force value.

4. The joining system according to claim 2, wherein the signal processing device comprises an algorithm configured to determine the joining force value from the force value and the acceleration value and to provide the joining force value as a function of the product of the acceleration value and an acceleration correction factor added to the product of the force value and the force correction factor added to the sum of a force offset and an acceleration offset.

5. The joining system according to claim 2, further comprising a control device that includes an algorithm;
wherein the control device is configured to detect the joining force value and compare the joining force value with a target force; and
wherein the control device is configured to cause the actuator to move in such a way that the joining force value approximates the target force.

6. The joining system according to claim 5, further comprising a displacement sensor configured to determine and provide a displacement value that can be unambiguously assigned to a spatial position of the joining tool; and
wherein the target force is dependent on the displacement value.

7. The joining system according to claim 2, wherein the signal processing device is configured to detect the force value and the acceleration value at a sampling rate of at least 10 kHz; or the signal processing device is designed to detect the force value and the acceleration value at least every 100 microseconds.

8. The joining system according to claim 2, wherein the signal processing device is configured to detect the force value and the acceleration value at a sampling rate of at least 1 kHz; or the signal processing device is designed to detect the force value and the acceleration value at least every millisecond.

9. The joining system according to claim 1, wherein the actuator is movable against the stator at a speed of more than 1500 mm·s⁻¹.

10. The joining system according to claim 1, wherein the actuator is movable against the stator at a speed of more than 400 mm·s⁻¹.

11. The joining system according to claim 1, further comprising a brake configured and disposed to brake the movement of the actuator relative to the stator;
wherein the drive is an electromechanical drive;
wherein the actuator is configured to be adjustable in a linear manner relative to the stator by means of the drive;
wherein the stator constitutes a fixed part of the joining system;
wherein the actuator and the stator are connected in a movable manner to at least one linear guide that restricts a linear movement of the actuator to a spatial axis;
wherein the force sensor is a piezoelectric force sensor;
wherein the accelerometer is a piezoelectric accelerometer; and
wherein the force sensor is arranged in a main force connection between the joining tool and the actuator.

12. The joining system according to claim 1, further comprising a brake configured and disposed to brake the movement of the actuator relative to the stator;
wherein the drive is an electromechanical drive;
wherein the actuator is configured to be adjustable in a linear manner relative to the stator by means of the drive;
wherein the stator constitutes a fixed part of the joining system;
wherein the actuator and the stator are connected in a movable manner to at least one linear guide that restricts a linear movement of the actuator to a spatial axis;
wherein the force sensor is a piezoresistive force sensor or a force sensor comprising strain gauges;
wherein the accelerometer is a piezoelectric accelerometer; and
wherein the force sensor is arranged in a main force connection between the joining tool and the actuator.

13. The joining system according to claim 1, further comprising a plurality of joining tools arranged in operative connection with the actuator in such a way that each respective one of the plurality of joining tools is configured to apply a respective joining force; and
wherein a respective force sensor is arranged between each respective joining tool and the actuator.

14. A process for applying a joining force to a workpiece by means of a joining system that includes a stator, a drive, an actuator, a joining tool, a force transducer disposed between the actuator and the joining tool and configured to measure a force acting on the joining tool as a force value, an accelerometer operatively connected to the joining tool to determine an acceleration value that measures an acceleration of the joining tool, wherein the actuator is rigidly connected to the force transducer and the joining tool, the process comprising the following steps:
using the drive to effect a controlled movement of the actuator that causes the joining tool to apply a joining force to the workpiece;
using the force transducer to determine the force value of the force acting on the joining tool during the controlled movement of the actuator;
using the accelerometer to determine the acceleration value that is a measure of an inertial force acting on the force transducer as the joining tool is accelerated during the controlled movement of the actuator; and
using the drive to move the actuator as a function of the force value and the acceleration value.

15. The process according to claim 14, further comprising using a signal processing device to detect the acceleration value of the accelerometer and the force value of the force transducer;
wherein the signal processing device includes an algorithm that determines an acceleration-compensated force value from the force value and the acceleration value;
wherein a control device detects the joining force value and compares the joining force value with a target force; and
wherein the control device moves the actuator depending on a difference between the target force and the joining force value.

16. The process according to claim 15, wherein the signal processing device detects the acceleration value simultaneously with the force value;
wherein a delay between the detection of the force value and the detection of the acceleration value is no greater than 50 microseconds;
wherein a displacement sensor unambiguously detects a spatial position of the joining tool as a displacement value; and
wherein the target force is dependent on the displacement value.

17. The process according to claim 16, wherein the algorithm of the signal processing device forms and provides the sum of the product of the acceleration value and acceleration correction factor and the product of force value and force correction factor and a force offset and an acceleration offset.

18. The process according to claim 14, wherein the actuator moves at a speed of more than 1500 mm·s⁻¹ relative to the stator; and
wherein the signal processing device detects the force value and the acceleration value at a sampling rate of at least 10 kHz, or the signal processing device detects the force value and the acceleration value at least every 100 microseconds.

19. The process according to claim 14, wherein the actuator moves at a speed of more than 400 mm·s⁻¹ relative to the stator; and
wherein the signal processing device detects the force value and the acceleration value at a sampling rate of at least 1 kHz, or the signal processing device detects the force value and the acceleration value at least every millisecond.
